(19) United States
(12) Patent Application Publication
(10) Pub. No.: US 2019/0196580 A1
(43) Pub. Date: Jun. 27, 2019

(54) LIGHT EMITTING APPARATUS, HEAD-MOUNTED DISPLAY, AND VIRTUAL REALITY SYSTEM

(71) Applicant: Nidec Corporation, Kyoto (JP)

(72) Inventors: Tetsuo ENOMOTO, Kyoto (JP); Akiko IKEDA, Kyoto (JP); Taro AMAGAI, Kyoto (JP)

(21) Appl. No.: 16/168,877

(22) Filed: Oct. 24, 2018

(30) Foreign Application Priority Data
Dec. 27, 2017 (JP) 2017-250579

(51) Int. Cl. G06F 3/01; G02B 27/01; G06F 3/03; G06T 19/00; G02B 27/00

(52) U.S. Cl. CPC G06F 3/012; G02B 27/017; G02B 27/0093; G06T 19/006; G06F 3/0304

(57) ABSTRACT

A light emitting apparatus emits light toward a real space in which a user wearing a head-mounted display is present. The light emitting apparatus includes a first light emitting unit that emits first light, which is used as a reference signal, a second light emitting unit that emits second light, which is used as a scanning signal that scans the real space at a timing based on the reference signal, and a controller that controls the first light emitting unit. The reference signal includes notification information to be submitted to the head-mounted display.

### CROSS REFERENCE TO RELATED APPLICATIONS

This application claims the benefit of priority to Japanese Patent Application No. 2017-250579 filed on Dec. 27, 2017. The entire contents of this application are hereby incorporated herein by reference.

### BACKGROUND OF THE INVENTION

### 1. Field of the Invention

The present disclosure relates to a light emitting apparatus, a head-mounted display, and a virtual reality system.

### 2. Description of the Related Art

In a known virtual reality system, an image in virtual space is displayed on a head-mounted display attached to the head of a user.

In a virtual reality system, the position of the head-mounted display attached to the user may be tracked to reflect the position and orientation of the head of the user in real space in an image in the virtual space. In a conventional practice, there is a case in which a base station, for example, is placed in real space in which the user is present and a light receiving unit is attached to the head-mounted display. The base station emits a beam that performs sweeping horizontally and vertically in the real space and also transmits a synchronization signal in the form of a non-directional optical pulse at the start of a sweeping cycle of the beam. The position of the head-mounted display is identified by measuring the length of time from a time at which the synchronization signal had been received to a time at which the beam was received.

However, the conventional system has been unable to transmit necessary information from the base station to the head-mounted display, so it has been impossible to flexibly change the operation of the system. For example, the conventional system has been unable to transmit a command to change the sweeping speed of a beam and information about the state of the base station (such as an error) to the head-mounted display at an appropriate time.

### SUMMARY OF THE INVENTION

An exemplary first disclosure in this application is a light emitting apparatus that emits light toward a real space in which a user wearing a head-mounted display is present. The light emitting apparatus includes a first light emitting unit that emits first light, which is used as a reference signal, a second light emitting unit that emits second light, which is used as a scanning signal that scans the real space at a timing based on the reference signal, and a controller that controls the first light emitting unit. The reference signal includes notification information to be submitted to the head-mounted display.

An exemplary second disclosure in this application is a head-mounted display that is attached to a user present in a real space and provides a virtual space to the user. The head-mounted display includes a first light sensing unit that senses first light and acquires a reference signal including notification information to be submitted to the head-mounted display, a second light sensing unit that senses second light and acquires a scanning signal that scans the real space at a timing based on the reference signal, and an extracting unit that extracts the notification information from the reference signal.

The above and other elements, features, steps, characteristics, and advantages of the present disclosure will become more apparent from the following detailed description of the preferred embodiments with reference to the attached drawings.

### BRIEF DESCRIPTION OF THE DRAWINGS

FIG. 1 illustrates a virtual reality system in a first exemplary embodiment of the present invention.

FIG. 2 is a perspective view of a light emitting apparatus in the first exemplary embodiment of the present invention.

FIG. 3 is a block diagram illustrating the structure of the light emitting apparatus in the first exemplary embodiment of the present invention.

FIG. 4 is a perspective view illustrating a state in which a head-mounted display in the first exemplary embodiment of the present invention is attached to a user.

FIG. 5 is a block diagram illustrating the structure of the head-mounted display in the first exemplary embodiment of the present invention.

FIG. 6 illustrates an example of the structure of a synchronization signal transmitted from the light emitting apparatus in the first exemplary embodiment of the present invention.

FIG. 7 is timing diagrams for various signals in the virtual reality system in the first exemplary embodiment of the present invention.

FIG. 8 is a block diagram illustrating the structure of a head-mounted display in a second exemplary embodiment of the present invention.

FIG. 9 is a circuit diagram illustrating an example of a band-pass filter included in an extracting unit in the head-mounted display in the second exemplary embodiment of the present invention.

### DETAILED DESCRIPTION OF THE PREFERRED EMBODIMENTS

A virtual reality system 1 in a first embodiment of the present disclosure will be described below.

In the virtual reality system 1 in this embodiment, a head-mounted display 3 is attached to the head of a user and a virtual reality world is provided to the user through the head-mounted display 3, as an example. That is, the virtual reality system 1 uses a computer to create an artificial digital environment and provides, to the user, a virtual reality world that makes the user feel as if the user were present in the artificial digital environment. In the virtual reality world, control is performed so that a virtual reality image provided to the user through the head-mounted display 3 is changed according to the position of the head of the user. Therefore, it is necessary to accurately track the position of the head-mounted display 3 attached to the user in succession.

In this embodiment, the position of the head-mounted display 3 indicates the placement (including the orientation and attitude) of the head-mounted display 3 in three-dimensional real space (space in a room in which the user is present, for example).

In view of this, the virtual reality system 1 in this embodiment includes a light emitting apparatus 2 that periodically repeats emission of non-directional light emitting diode (LED) light to a real world in which the user is present and emission of laser light (beam) with which the scanning of the real world in which the user is present is started in synchronization with the emission of the LED light. When, for example, the room in which the user is present is scanned, the whole of the room is illuminated by planar laser light at a constant scanning speed. A light sensing unit, which will be described later, is included in the head-mounted display 3. A plurality of light sensing units are preferably included.

In the virtual reality system 1 in this embodiment, an angle between a position from which scanning by laser light starts and the position of the light sensing unit in the head-mounted display 3 is identified from a difference between a time at which the light sensing unit in the head-mounted display 3 received LED light and a time at which the light sensing unit received laser light.

Preferably, laser light scans in succession along two directions that are mutually orthogonal. Thus, an angle from the position from which scanning by the light sensing unit in the head-mounted display 3 is started is identified in each of the two mutually orthogonal directions, enabling the position of the head-mounted display 3 to be identified in the three-dimensional real space.

The directions of scanning by laser light are not limited to two mutually orthogonal directions. For example, an angle formed by two scanning directions may be smaller than 90 degrees or may be larger than 90 degrees.

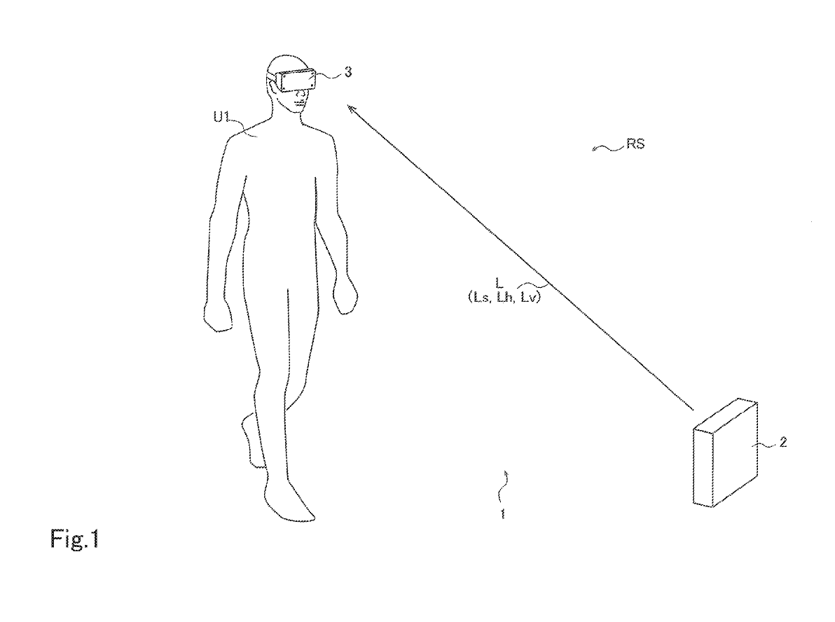

FIG. 1 illustrates the virtual reality system 1 in the first embodiment.

As illustrated in FIG. 1, the virtual reality system 1 includes the light emitting apparatus 2 and the head-mounted display 3 attached to a user U1. The light emitting apparatus 2 and user U1 are present in predetermined real space RS. The real space RS is preferably closed space such as in the interior of a room.

The light emitting apparatus 2 emits light L toward the real space RS in which the user U1 to which the head-mounted display 3 is attached is present. The light emitting apparatus 2 is placed at a position at which the emitted light L can cover as wide a range in the real space RS as possible. The user U1 freely can move in the real space RS and can view a virtual reality image of a predetermined content through the head-mounted display 3.

Although described later in detail, the light L emitted from the light emitting apparatus 2 includes LED light Ls, laser light Lh, and laser light Lv. The LED light Ls is used as a synchronization signal (an example of a reference signal), which is a type of pulse signal, that becomes a starting point of a timing at which to emit laser light Lh and laser light Lv. The laser light Lh and laser light Lv are used as scanning signals that scan the real space RS starting from a time at which the LED light Ls is emitted (that is, at a timing based on the synchronization signal). The laser light Lh horizontally scans the real space RS. The laser light Lv vertically scans the real space RS.

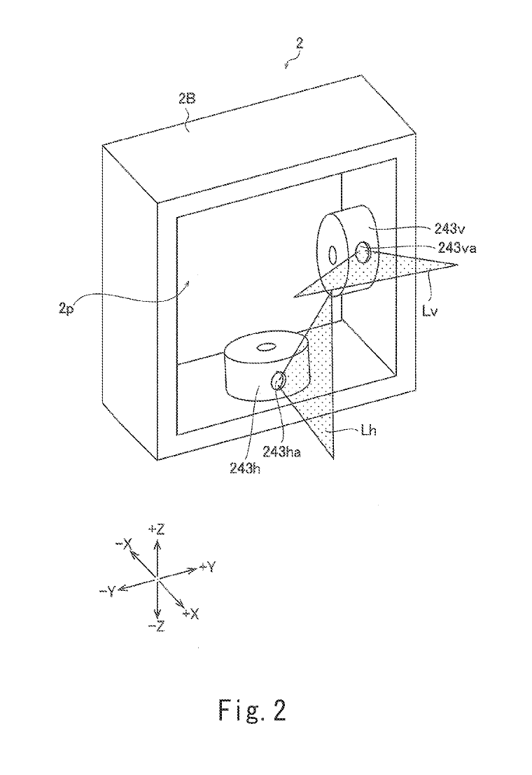

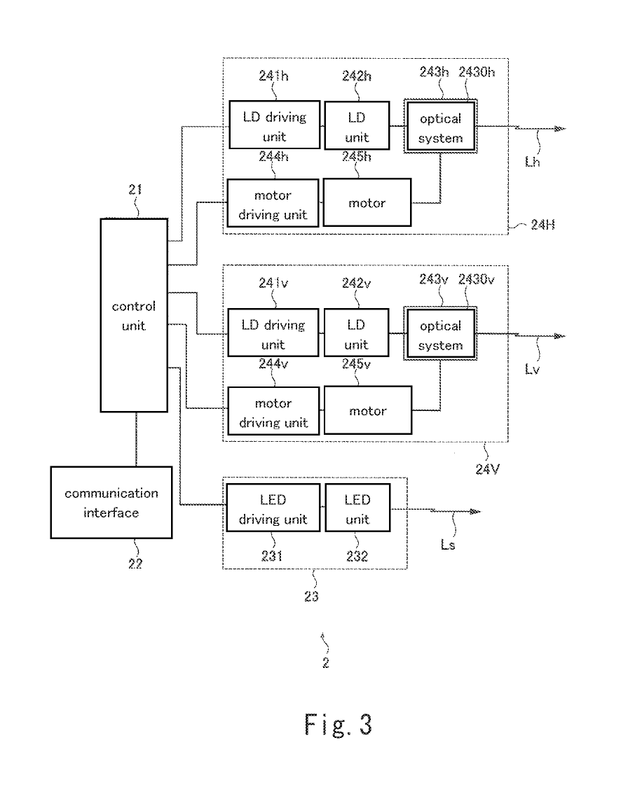

Next, the light emitting apparatus 2 in this embodiment will be described with reference to FIGS. 2 and 3. FIG. 2 is a perspective view of the light emitting apparatus 2 in this embodiment. FIG. 3 is a block diagram illustrating the structure of the light emitting apparatus 2 in this embodiment.

As illustrated in FIG. 2, the outline shape of the light emitting apparatus 2 is formed by a casing 2B, which is a substantially rectangular parallelepiped. A light emitting surface 2p, which is open, is formed in the casing 2B. For explanation purposes, a coordinate system indicated in FIG. 2 is defined.

As illustrated in FIG. 2, the light emitting apparatus 2 has two rotors denoted 243h and 243v through the light emitting surface 2p. The rotor 243h has a light emitting opening 243ha and a rotational mechanism that rotates around the z axis and horizontally moves the light emitting opening 243ha. The rotor 243v has a light emitting opening 243va and a rotational mechanism that rotates around the y axis and vertically moves the light emitting opening 243va.

As illustrated in FIG. 3, the light emitting apparatus 2 has a controller 21, a communication interface 22, and light emitting units 23, 24H and 24V. The light emitting unit 23 is an example of a first light emitting unit. The light emitting units 24H and 24V are each an example of a second light emitting unit.

The controller 21, which has a microcontroller, controls the entire operation of the light emitting apparatus 2. For example, the controller 21 determines timings at which to emit LED light Ls, laser light Lh and laser light Lv, and controls the rotors 243h and 243v so that they rotate at rotational speed settings.

The communication interface 22 is linked to an external computer apparatus (not illustrated) so that wireless or wired communication with it is possible. The communication interface 22 receives a command from the computer apparatus and transmits the received command to the controller 21. Commands are used to, for example, change various parameters including the rotational speeds of the rotors 243h and 243v in the light emitting apparatus 2.

The light emitting unit 23 emits LED light Ls (an example of first light), which is used as a synchronization signal. The light emitting units 24H and 24V respectively emit laser light Lh and laser light Lv (which are each an example of second light), which are used as scanning signals that scan the real space RS at a timing based on the synchronization signal.

The light emitting unit 23 includes an LED driving unit 231 and an LED unit 232. The LED unit 232 has one or a plurality of LEDs. The LED driving unit 231 has a driving circuit that receives a control signal from the controller 21 and creates driving signals that drive the LEDs included in the LED unit 232 from the received control signal. When each LED in the LED unit 232 is turned on, non-directional LED light Ls is emitted from the light emitting unit 23.

As described above, the LED light Ls is used as a synchronization signal. In this embodiment, a synchronization signal is a pulse signal including notification information to be submitted to the head-mounted display 3. To create a pulse signal including notification information, the LED unit 232 is controlled by the controller 21 so as to blink in a predetermined pattern. Notification information will be described later.

The light emitting unit 24H includes a laser diode (LD) driving unit 241h, a laser diode (LD) unit 242h, the rotor 243h, a motor driving unit 244h, and a motor 245h.

The LD driving unit 241h creates a predetermined constant current used to drive the LD unit 242h. The LD driving unit 241h has a switching element connected to the LD unit 242h. The LD driving unit 241h receives a control signal from the controller 21 and turns on and off the switching element according to the received control signal to control current carrying to the LD unit 242h.

The LD unit 242h has, for example, one or more laser diodes. When the LD unit 242h has a single laser diode, the LD unit 242h directly emits laser light Lh. When the LD unit 242h has a plurality of laser diodes, the LD unit 242h uses a condenser to focus laser light from the plurality of laser diodes and outputs the focused laser light Lh.

The motor driving unit 244h receives a control signal from the controller 21 and creates a driving current that drives the motor 245h from the received control signal. Although the motor 245h may be any type of motor, the motor 245h is, for example, a direct-current (DC) brushless motor. The motor 245h starts to rotate the rotor 243h at a predetermined timing by using the driving current created by the motor driving unit 244h, after which the motor 245h rotates the rotor 243h at a predetermined rotational speed.

An optical system 2430h is incorporated into the rotor 243h. The optical system 2430h has one or a plurality of lenses that lead laser light transmitted from the LD unit 242h to the light emitting opening 243ha. The optical system 2430h is provided to output planar laser light.

The light emitting unit 24H having the structure described above starts to emit planar laser light Lh at a timing commanded by the controller 21 and also emits laser light Lh used as a scanning signal that horizontally scans while the rotor 243h is being rotated horizontally.

The light emitting unit 24V includes an LD driving unit 241v, an LD unit 242v, a rotor 243v, a motor driving u nit 244v, and a motor 245v. The light emitting unit 24V, having a structure similar to the structure of the light emitting unit 24H, operates similarly to the light emitting unit 24H, but differs from the light emitting unit 24H in that the light emitting unit 24V emits laser light Lv used as a scanning signal that vertically scans while the rotor 243v is being rotated vertically.

That is, the scanning signals in this embodiment include a first scanning signal, implemented by laser light Lh, and a second scanning signal, implemented by laser light Lv, each of which scans the real space RS along one of two mutually orthogonal directions.

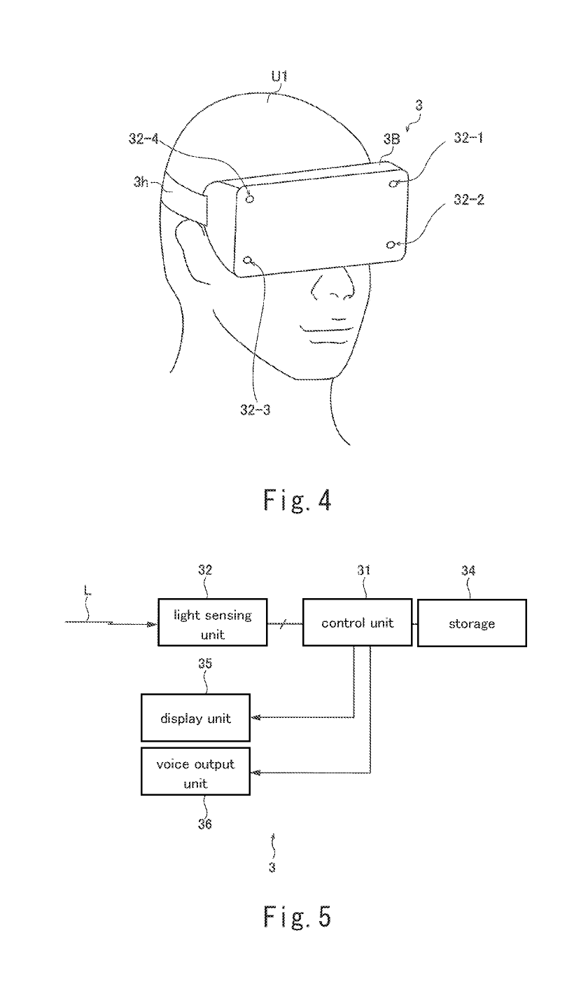

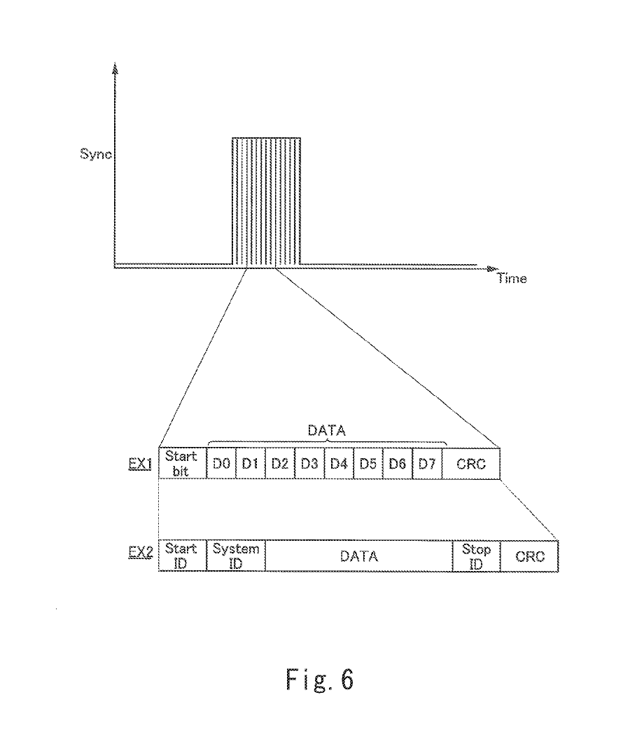

Next, the head-mounted display 3 in this embodiment will be described with reference to FIGS. 4 to 6. FIG. 4 is a perspective view illustrating a state in which the head-mounted display 3 in this embodiment is attached to the user U1. FIG. 5 is a block diagram illustrating the structure of the head-mounted display 3 in this embodiment. FIG. 6 illustrates an example of the structure of a synchronization signal transmitted from the light emitting apparatus 2 in this embodiment.

The head-mounted display 3 is a goggle-type display attached to the head of the user U1 as illustrated in FIG. 4. The form of the head-mounted display 3 illustrated in FIG. 4 is just an example. The head-mounted display 3 may be of a helmet type. Although the head-mounted display 3 illustrated in FIG. 4 is of a non-transparent type (immersive type) that completely covers the eyes, this is not a limitation; the head-mounted display 3 may a transparent-type display through which the circumference is visible.

The head-mounted display 3 has a main body 3B and a head band 3h by which the main body 3B is attached to the head. The main body 3B has a plurality of light sensing units denoted 32-1 to 32-4. Although four light sensing units are provided in the example in FIG. 4, there is no limitation on the number of light sensing units. In a common reference to the light sensing units 32-1 to 32-4 in the description below, they will be collectively referred to as the light sensing unit 32.

The head-mounted display 3 has a controller 31, the light sensing units 32, a storage 34, a display unit 35, and a voice output unit 36, as illustrated in FIG. 5.

The controller 31, which has a microcontroller, controls the entire operation of the head-mounted display 3.

Each light sensing unit 32 includes a photodiode used as a light receiving element and also has an electronic circuit that amplifies an electric signal as necessary, the electric signal being obtained through opto-electric conversion by the photodiode. The photodiode is just an example of a light receiving element. Any structure can be used as a light receiving element if the structure has a mechanism that can detect light. For example, a photoresistor may be used as a light receiving element.

The light sensing unit 32 is an example of a first light sensing unit and a second light sensing unit. Specifically, the light sensing unit 32 used as the first light receiving element detects LED light Ls emitted from the light emitting apparatus 2, and acquires a synchronization signal including notification information to be submitted to the head-mounted display 3. The light sensing unit 32 used as the second light sensing unit detects laser light Lh and laser light Lv emitted from the light emitting apparatus 2, and acquires scanning signals that scan the real space RS at a timing based on the synchronization signal.

Notification information included in a synchronization signal includes at least any of first information and second information. The first information identifies the head-mounted display 3. The second information is at least any of information about the operation state of the light emitting apparatus 2, information indicating a setting of the light emitting apparatus 2, and information indicating a command to change a setting of the light emitting apparatus 2.

Information about the operation state of the light emitting apparatus 2 is, for example, information indicating that the light emitting apparatus 2 is normal or abnormal or in another state. Information indicating a setting of the light emitting apparatus 2 is, for example, information about a setting parameter for the light emitting apparatus 2 such as the rotational speed of the rotor 243h or 243v. Information indicating a command to change a setting of the light emitting apparatus 2 is, for example, information about a command to change the rotational speed of the rotor 243h or 243v.

The first information and second information are not limited to the above examples. They may include any information useful for the system.

In a first example EX1 illustrated in FIG. 6, notification information composed of a bit string including a start bit, an 8-bit data string (data), and a cyclic redundancy check (CRC) code, which is an error detecting code, is superimposed in a synchronization signal Sync, which is a pulse signal. The start bit is a code that causes the receiving side to recognize that the transmission of notification information has been started. At least any of the first information and second information is included in the 8-bit data string.

Since the notification information in the first example is composed of a relatively short bit string, the notification information occupies only the small amount of information in the synchronization signal Sync.

In a second example EX2 illustrated in FIG. 6, notification information composed of a bit string including a start ID, a system ID, a data string (data), a stop ID, and a cyclic redundancy check (CRC) code, which is an error detecting code, is superimposed in a synchronization signal Sync. The start ID is a code that causes the receiving side to recognize that the transmission of notification information has been started. The system ID is a particular ID assigned to a system (or content) used by the user at the transmission destination so that the synchronization signal is distinguished from a synchronization signal destined for another user. At least any of the first information and second information is included in the data string (data), as in the first example. The stop ID is a code that causes the receiving side to recognize that the transmission of notification information has been terminated.

Since the notification information in the second example is composed of a relatively long bit string, it is preferable to set a high transfer rate.

To create the pulse signal indicated in the examples in FIG. 6, emission of LED light Ls is enabled and disabled by controlling the light emitting unit 23 under the controller 21.

Referring again to FIG. 5, the controller 31 in the head-mounted display 3 converts the synchronization signal, which is a signal sensed by the light sensing unit 32, from analog to digital, performs CRC to detect an error, and acquires the notification information transmitted from the head-mounted display 3. The controller 31 also records a time at which the synchronization signal was received.

In this embodiment, the controller 31 is an example of an extracting unit that extracts notification information to be submitted to the head-mounted display 3 from the synchronization signal.

As described above, in the virtual reality system 1 in this embodiment, serial communication is performed between the light emitting apparatus 2 and the head-mounted display 3 through transmission and reception of a synchronization signal.

The light sensing unit 32 detects laser light Lh and laser light Lv emitted from the light emitting apparatus 2 and acquires analog values of scanning signals.

The controller 31 converts the scanning signal acquired by the light sensing unit 32 from analog to digital, captures the converted signal, and records a time at which the scanning signal was received. The controller 31 then performs processing (i) to (iv) below.

(i) Processing to calculate a difference between the time at which the synchronization signal was received and the time at which the scanning signal was received

(ii) Processing to calculate an angle of the light sensing unit 32 from the scanning start point in the real space RS in two directions, horizontal and vertical, according to the rotational speeds of the rotors 243h and 243v and the difference

(iii) Processing to identify the position of the light sensing unit 32 (specifically, the positions of the light sensing units 32-1 to 32-4) from the angles calculated in (ii) above

(iv) Processing to identify the position of the head-mounted display 3 according to the results in (iii) above

Referring again to FIG. 5, the storage 34 stores an application that reproduces a virtual reality content (such as a game content) that the user U1 views and listens to by wearing the head-mounted display 3. When the head-mounted display 3 is activated, the controller 31 loads the application from the storage and executes the application, providing a virtual reality content to the user U1.

The display unit 35 includes a display panel attached to the main body 3B of the head-mounted display 3. The display panel displays a virtual reality image according to the result of the application execution by the controller 31. At that time, an image for which the point of view of the virtual space has been adjusted according to the position of the head-mounted display 3, the position being calculated by the controller 31 in succession, is displayed on the display unit 35.

The voice output unit 36 includes a speaker (not illustrated), from which the voice output unit 36 outputs a voice according to the result of the application execution by the controller 31.

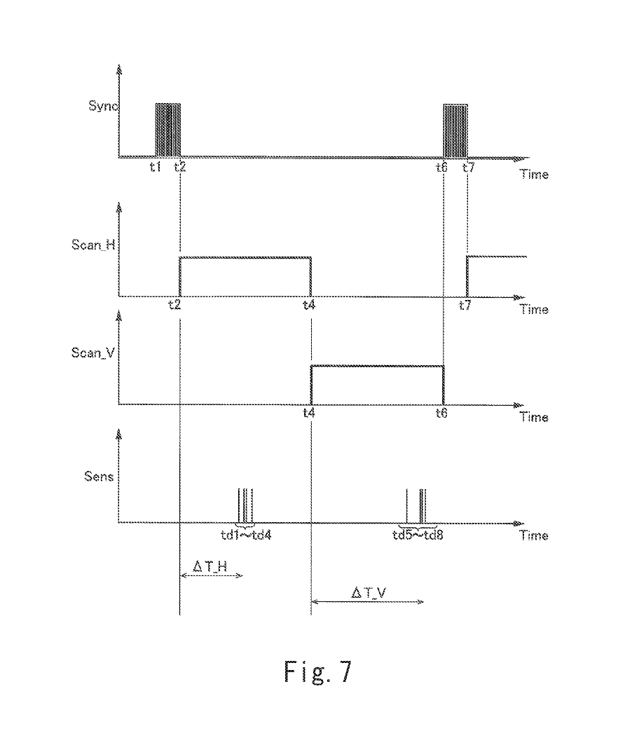

Next, the operation of the virtual reality system 1 in this embodiment will be described with reference to FIG. 7. FIG. 7 is timing diagrams for various signals in the virtual reality system 1 in this embodiment.

The timing diagrams in FIG. 7 are for the synchronization signal Sync, a horizontal scanning signal Scan_H, a vertical scanning signal Scan_V, and a signal Sens sensed by the light sensing unit 32.

Although, FIG. 7 illustrates, as an example, a case in which the light emitting apparatus 2 first transmits a synchronization signal Sync and then transmits a horizontal scanning signal Scan_H and a vertical scanning signal Scan_V in succession in that order, this is not a limitation. After having transmitted a synchronization signal Sync, the light emitting apparatus 2 may transmit a horizontal scanning signal Scan_H and then may transmit a synchronization signal Sync again, after which the light emitting apparatus 2 may transmit a vertical scanning signal Scan_V. A horizontal scanning signal Scan_H and a vertical scanning signal Scan_V may not be transmitted in that order. A vertical scanning signal Scan_V may be transmitted first.

In the example illustrated in FIG. 7, the light emitting apparatus 2 emits LED light Ls, which is used as a synchronization signal Sync, during a period from time t1 to time t2. Then, emission of laser light Lh, which is used as a horizontal scanning signal Scan_H, starts in synchronization with a falling edge of the synchronization signal Sync (at time t2). Emission of laser light Lh, which is used as a horizontal scanning signal Scan_H, is performed during a period from time t2 to time t4.

The sensed signal Sens is observed by the light sensing units 32-1 to 32-4 of the head-mounted display 3 during a period from time td1 to time td4 in the period from time t2 to time t4. The controller 31 in the head-mounted display 3 calculates a difference between time t2 and each of times td1 to td4 (in FIG. 7, differences between time t2 and times td1 to td4 are collectively indicated as ΔT_H), and calculates the angle of each light sensing unit 32 in the horizontal direction from the scanning start point in the real space RS.

At time t4 at which the emission of laser light Lh, which is used as a horizontal scanning signal Scan_H, is terminated, emission of laser light Lv, which is used as a vertical scanning signal Scan_V, is started. Laser light Lv, which is used as vertical scanning signal Scan_V, is emitted during a period from time t4 to time t6.

The sensed signal Sens is observed by the light sensing units 32-1 to 32-4 of the head-mounted display 3 during a period from time td5 to time td8 in the period from time t4 to time t6. The controller 31 in the head-mounted display 3 calculates a difference between time t4 and each of times td5 to td8 (in FIG. 7, differences between time t4 and times td5 to td8 are collectively indicated as ΔT_V), and calculates the angle of each light sensing unit 32 in the vertical direction from the scanning start point in the real space RS.

Processing in one cycle is completed in a period from time t1 to time t6. At time t6, the controller 31 in the head-mounted display 3 identifies the horizontal and vertical positions, in the real space RS, of each light sensing unit 32 attached to the head-mounted display 3 with respect to the scanning start position. Therefore, the position of the head-mounted display 3 can be identified.

At time t6, emission of LED light Ls, which is used as a synchronization signal Sync, is started again. After that, processing to identify the position of the head-mounted display 3 is repeatedly performed. The light emitting apparatus 2 operates at, for example 60 Hz (the length of one cycle is about 16.7 ms).

As described above, in the virtual reality system 1 in this embodiment, a cycle is repeatedly performed in which the light emitting apparatus 2 emits LED light, which is used as a synchronization signal, and then emits laser light, which is used as a scanning signal, in synchronization with the synchronization signal to track the position of the head-mounted display 3 in succession. The display of a virtual reality image reproduced by the head-mounted display 3 is controlled according to the position of the head-mounted display 3, reproducing a virtual reality world matching the orientation of the head of the user U1.

In this embodiment, notification information to be submitted to the head-mounted display 3 is included in a synchronization signal that is periodically transmitted from the light emitting apparatus 2 to the head-mounted display 3. Therefore, useful information can be transmitted to the head-mounted display 3 at an appropriate time. Examples of this type of useful information include information indicating whether there is an error in the light emitting apparatus 2 and information as to, for example, a setting change in the light emitting apparatus 2. Since the head-mounted display 3 can acquire this type of information at an appropriate time, the head-mounted display 3 can execute error handling at the time of an emergency, processing to respond to a change in the rotational speed of a rotor in the light emitting apparatus 2, and other processing that is needed immediately.

Next, a second embodiment of the virtual reality system 1 in the present disclosure will be described. The description below will mainly focus on differences from the first embodiment.

This embodiment is intended to, even if there is optical noise (such as light from a fluorescent lamp or infrared light from a remote control) in real space in which a user is present, prevent a problem from occurring in communication between the light emitting apparatus 2 and a head-mounted display 3A in this embodiment.

Conventionally, there has been the following problem caused by optical noise in real space in which a user is present. For example, there has been the possibility that when light due to optical noise interferes with LED light emitted from a light emitting apparatus, a light sensing unit in a head-mounted display cannot correctly sense light from the light emitting apparatus or incorrectly senses light.

Another problem has been that, in a situation in which two or more light emitting apparatuses are used in a single room and two or more users view and listen to different virtual reality contents, if a light sensing unit in a head-mounted display attached to one user receives LED light directed to another user (or intended for to another content), a timing to receive a synchronization signal may be delayed or advanced. In this case, each user failed to correctly view and listen to a content.

In view of this, in this embodiment, notification information to be submitted to the head-mounted display 3A is superimposed in a synchronization signal, which is a pulse signal, transmitted from the light emitting apparatus 2 as a high-frequency signal having a higher frequency than the pulse signal. The high-frequency signal to be superimposed in the synchronization signal has a frequency assigned to the head-mounted display 3A at the transmission destination in advance. When a filter is used to extract the high-frequency signal from the synchronization signal sensed by the light sensing unit 32, the head-mounted display 3A can reliably obtain intended notification information (that is, notification information destined for the head-mounted display 3A). That is, since optical noise other than from the light emitting apparatus 2 and a signal due to LED light directed to another user (or intended for another content) can be removed by a filter, it is possible to more reliably transmit notification information to the head-mounted display 3A through a synchronization signal.

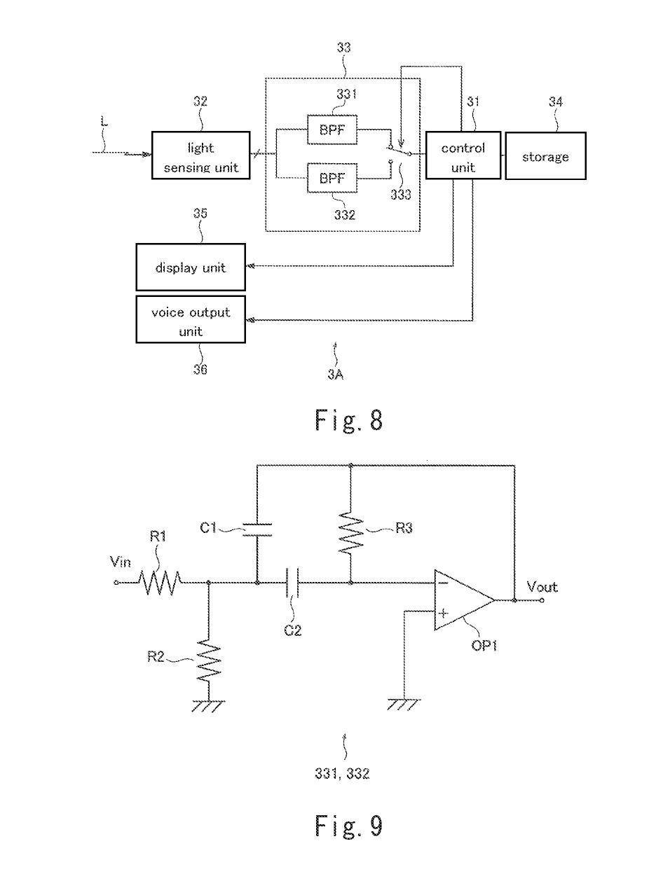

Next, the head-mounted display 3A in this embodiment will be described with reference to FIGS. 8 and 9. FIG. 8 is a block diagram illustrating the structure of the head-mounted display 3A in this embodiment. FIG. 9 is a circuit diagram illustrating an example of a band-pass filter included in an extracting unit 33 in the head-mounted display 3A in this embodiment.

As illustrated in FIG. 8, the head-mounted display 3A in this embodiment differs from the head-mounted display 3 (see FIG. 5) in the first embodiment in that the head-mounted display 3A has the extracting unit 33.

In the example in FIG. 8, the extracting unit 33 has band-pass filters 331 and 332 and a switch 333. The band-pass filters 331 and 332 each extract a high-frequency signal (that is, notification information) from a synchronization signal, which is a pulse signal. The switch 333 is an analog switch that can be made switchable by the controller 31.

An example of the circuit structure of the band-pass filters 331 and 332, which are each an analog band-pass filter, is illustrated in FIG. 9.

FIG. 9 illustrates just an example of an analog band-pass filter. Various circuit structures of analog band-filters are known. The band-pass filters used in this embodiment may have any circuit structure if a desired pass center frequency f_{c} is obtained.

The transfer function G(s) of the circuit illustrated in FIG. 9 is represented as in expression (1). The pass center frequency f_{c} is represented as in expression (2).

$$\begin{matrix}G ( s ) = \frac{{v}_{out} ( s )}{{v}_{in} ( s )} = \frac{- \frac{1}{R 1 C 1} s}{{s}^{2} + s ( \frac{1}{R 3 C 2} + \frac{1}{R 3 C 1} ) + \frac{1}{R 3 C 1 C 2} ( \frac{1}{R 1} + \frac{1}{R 2} )} & ( 1 ) \\ {f}_{C} = \frac{1}{2 π} \sqrt{\frac{1}{R 3 C 1 C 2} ( \frac{1}{R 1} + \frac{1}{R 2} )} & ( 2 )\end{matrix}$$

In the extracting unit 33 in FIG. 8, the band-pass filters 331 and band-pass filter 332 are set so that they have different pass center frequencies f_{c}. Specifically, the pass center frequency f_{c} of the band-pass filter 331 is F1 and the pass center frequency f_{c} of the band-pass filter 332 is F2 (F2 is not equal to F1).

In this embodiment, the output terminal of the band-pass filter 331 is connected to one terminal of the switch 333 and the output terminal of the band-pass filter 332 is connected to another terminal of the switch 333. The connection state of the switch 333 is controlled by the controller 31.

In the structure illustrated in FIG. 8, the reason why band-pass filters having different pass center frequencies f_{c} are provided so as to be selectively used is to enable notification information included in a synchronization signal to be selectively transmitted in two different contents or systems.

In a case in which two users view and listen to different virtual reality contents CT1 and CT2 in a single room, for example, two light emitting apparatuses are provided in the room. Then, a light emitting apparatus corresponding to the virtual reality content CT1 transmits a synchronization signal in which a notification signal at the frequency F1 is superimposed and a light emitting apparatus corresponding to the virtual reality content CT2 transmits a synchronization signal in which a notification signal at the frequency F2 is superimposed.

The controller 31 in the head-mounted display 3A corresponding to the virtual reality content CT1 controls the switch 333 so that the band-pass filter 331, the pass center frequency of which is F1, is selected. The controller 31 in the head-mounted display 3A corresponding to the virtual reality content CT2 controls the switch 333 so that the band-pass filter 332, the pass center frequency of which is F2, is selected. When band-pass filters having different pass center frequencies f_{c} are provided in the head-mounted display 3A so as to be selectively used as described above, it is possible to prevent incorrect sensing between head-mounted displays 3A that reproduce different contents in a single real space RS.

As described above, in the virtual reality system 1 in this embodiment, notification information is superimposed in a synchronization signal, which is a pulse signal, transmitted by the light emitting apparatus 2 as a high-frequency signal having a higher frequency than the pulse signal. The extracting unit 33 in the head-mounted display 3A uses filters to remove signals due to light from another light source other than the light emitting apparatus 2 and LED light directed to another user (or intended for to another content). Therefore, it is possible to more reliably transmit notification information to the head-mounted display 3A through a synchronization signal.

Another advantage is that since notification information is superimposed in a synchronization signal as a high-frequency signal, the notification information is transmitted highly efficiently.

Although, in the structure illustrated in FIG. 8, two band-pass filters that can be selectively used are provided, there is no limit on the number of selectively used band-pass filters. As would be apparent to one skilled in the relevant art, three or more band-pass filters each of which has a different pass center frequencies f_{c} can be provided so that they are selectively used.

From the viewpoint of removing light coming from another light source, the extracting unit 33 may be a single filter. When light from a fluorescent lamp is to be removed as noise, since domestic fluorescent lamps generally blink at 100 or 120 Hz, it suffices to provide a single filter that adequately attenuates a light pulse signal at 100 or 120 Hz (the filter is not limited to a band-pass filter, but may be a low-pass filter or a high-pass filter may).

Although, in the examples in FIGS. 8 and 9, a case in which analog band-pass filters are provided has been described, digital filters may be used. In this case, two digital filters (each of which is an example of the extracting unit) equivalent to the band-pass filters 331 and 332 are provided in the controller 31. The controller 31 converts a signal sensed by the light sensing unit 32 from analog to digital and obtains a digital value, after which the controller 31 performs filtering on the digital value by using the above two digital filters. The controller 31 then selects one of outputs from the two digital filters and obtains target notification information (that is, notification information destined to the controller 31).

The digital filter may be of a finite impulse response (FIR) type or an infinite impulse response (IIR) type.

An advantage of using digital filters is that the setting of the pass center frequency f_{c} can be easily changed.

Instead of the examples illustrated in FIGS. 8 and 9, a method may be used by which a timer included in a microcomputer in the controller 31 is used to acquire target notification information. In this method, the head-mounted display 3A needs to be assigned the frequency of a signal including the target notification information in advance.

Specifically, the controller 31 converts a signal sensed by the light sensing unit 32 from analog to digital and obtains a digital value, after which the controller 31 measures a time Ts between two adjacent rising edges (or two adjacent falling edges) of the sensed signal with the timer. If the time Ts is a value within a predetermined range stipulated by the reciprocal of the assigned frequency, the controller 31 decides that the received sensed signal is the target signal.

Since the sensed signal may include a noise component or an unintended signal, a structure is preferably used together with the analog filters or digital filters to remove the noise component or unintended signal.

So far, a plurality of embodiments of the present disclosure have been described. However, the present disclosure is not limited to the above embodiments. The above embodiments can be improved or modified in various forms without departing from the intended scope of the present invention.

For example, in the second embodiment, a case has been described in which notification information to be submitted to the head-mounted display 3A is superimposed in a synchronization signal, which is a pulse signal, transmitted from the light emitting apparatus 2 as a high-frequency signal having a higher frequency than the pulse signal. An aspect to include notification information in a synchronization signal is not limited to the superimposition of a high-frequency signal; another method may be used. For example, the amplitude of a synchronization signal may be modulated to include notification information in the synchronization signal.

In the embodiments described above, a case has been described in which notification information is included in a synchronization signal transmitted from the light emitting apparatus 2. However, the notification information may also be included in a scanning signal transmitted from the light emitting apparatus 2. Specifically, in FIG. 3, the controller 21 in the light emitting apparatus 2 may control the light emitting units 24H and 24V so that notification information is included in a scanning signal through laser light Lh and laser light Lv. Thus, in a case in which a plurality of light emitting apparatuses 2 are placed in a single room, when an ID that identifies the head-mounted display 3 is included in a scanning signal as notification information, the head-mounted display 3 can reliably receive the target scanning signal (that is, the scanning signal destined for the head-mounted display 3).

In the embodiments described above, a case has been described in which the light emitting units 24H and 24V, each of which is an example of the second light emitting apparatus, use a laser diode (semiconductor laser). However, this is not a limitation. Another type of laser (such as, for example, a gas laser or a liquid laser) may be used.

In the embodiments described above, a case has been described in which four light sensing units 32 are provided in the head-mounted display 3 or 3A. However, there is no limitation on the number of light sensing units 32. The number of light sensing units 32 can be appropriately determined according to the capacity of calculation and/or a system request.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A light emitting apparatus that emits light toward a real space in which a user wearing a head-mounted display is present, the light emitting apparatus comprising:
a first light emitting unit that emits first light, which is used as a reference signal;
a second light emitting unit that emits second light, which is used as a scanning signal that scans the real space at a timing based on the reference signal; and
a controller that controls the first light emitting unit; wherein
the reference signal includes notification information to be submitted to the head-mounted display.

2. The light emitting apparatus according to claim 1, wherein
the reference signal is a pulse signal; and
the notification information has been superimposed in the pulse signal as a high-frequency signal having a higher frequency than the pulse signal.

3. The light emitting apparatus according to claim 1, wherein the notification information includes first information that identifies the head-mounted display.

4. The light emitting apparatus according to claim 1, wherein the notification information includes second information, which is at least any of information about an operation state of the light emitting apparatus, information indicating a setting of the light emitting apparatus, and information indicating a command to change a setting of the light emitting apparatus.

5. The light emitting apparatus according to claim 1, wherein
the controller controls the second light emitting unit; and
the scanning signal includes the notification information.

6. The light emitting apparatus according to claim 1, wherein the scanning signal include a first scanning signal and a second scanning signal, each of which scans the real space along one of two mutually orthogonal directions.

7. The light emitting apparatus according to claim 1, wherein
the first light is light emitted from a light emitting diode; and
the second light is laser light.

8. A head-mounted display that is attached to a user present in a real space and provides a virtual space to the user, the display comprising:
a first light sensing unit that senses first light and acquires a reference signal including notification information to be submitted to the head-mounted display;
a second light sensing unit that senses second light and acquires a scanning signal that scans the real space at a timing based on the reference signal; and
an extracting unit that extracts the notification information from the reference signal.

9. The head-mounted display according to claim 8, wherein
the reference signal is a pulse signal; and
the notification information has been superimposed in the pulse signal as a high-frequency signal having a higher frequency than the pulse signal.

10. The head-mounted display according to claim 9, wherein the extracting unit includes a filter that extracts the high-frequency signal from the pulse signal.

11. The head-mounted display according to claim 8, wherein the notification information includes first information that identifies the head-mounted display.

12. A virtual reality system comprising:
the light emitting apparatus according to claim 1; and
the head-mounted display; wherein
the head-mounted display includes:
a first light sensing unit that senses the first light and acquires the reference signal;
a second light sensing unit that that senses the second light and acquires the scanning signal; and
an extracting unit that extracts the notification information from the reference signal.
